(19) United States
(12) Patent Application Publication
(10) Pub. No.: US 2003/0045146 A1
(43) Pub. Date: Mar. 6, 2003

(54) Cable reel

(75) Inventor: Shoichi Sugata, Yokkaichi-city (JP)

Correspondence Address: GREENBLUM & BERNSTEIN, P.L.C., 1941 ROLAND CLARKE PLACE, RESTON, VA, 20191, US

(73) Assignee: SUMITOMO WIRING SYSTEMS, LTD., Yokkaichi-city (JP)

(21) Appl. No.: 10/231,269

(22) Filed: Aug. 30, 2002

(30) Foreign Application Priority Data
Aug. 31, 2001 (JP) 2001-263515
Sep. 12, 2001 (JP) 2001-276551

(51) Int. Cl. H01R 13/62

(52) U.S. Cl. 439/154

(57) ABSTRACT

In a cable reel, a movable inner sleeve is rotatably coupled to a stationary outer sleeve and a flat cable is contained in an annular chamber defined between the sleeves. An end of the flat cable is connected through bus bars to wires of an external circuit. A connection member holds intermediate portions of the bus bars. A distal end of the flat cable abuts a lower stopper wall of the connection member and comes into contact with the bottom surfaces of the bus bars. Distal ends of the external circuit wires abut an upper stopper wall of the connection member and come into contact with top surfaces of the bus bars. The connection members are stacked to form an air insulation layer between the stacked members by providing lower walls on the bottom of an upper level connection member and upper partitions on the top of a lower level connection member.

### BACKGROUND OF THE INVENTION

1. Field of the Invention

The present invention relates to a cable reel to be mounted on a steering device for a vehicle, such as an automobile, and more particularly relates to a cable reel in which a plurality of flat cables are contained, and in which sections connected between ends of conductors in the flat cable and external electric wires are stacked to hold the sections at a given position while maintaining an interlayer insulation, and to connection portions which interconnect conductors of a flat cable contained in a cable reel and external electric wires through bus bars.

2. Description of the Related Art

A conventional cable reel will be described with reference to FIGS. 6 and 7. FIG. 6 is a sectional top view of a conventional cable reel and FIG. 7 is an exploded perspective view of a conventional inner case.

The conventional cable reel shown in FIG. 6 includes a stationary body 1 to be secured to a steering column and a movable body 2 to be secured to a steering wheel. The movable body 2 is rotatably coupled to the stationary body 1. Two semicircular guide rings 3 are disposed in an annular chamber defined between the stationary body 1 and the movable body 2. Two flat cables 5 are contained in the cable reel by turning back the flat cables 5 through two counter-turn spaces or clearances C defined between the two guide rings 3. The flat cables may also be accommodated in the cable reel in a scroll manner.

Connections between the opposite ends of conductors 5a of two flat cables 5 and external wires are shown in FIG. 7. Bus bars 9 are fixed in inner cases 4 and 6 in any suitable manner, such as by molding or pressing. The conductors 5a are connected to ends of the bus bars 9 in any suitable manner, such as by ultrasonic welding, while core elements of lead wires L/W of an external circuit are connected to the opposite ends of the bus bars 9 in any suitable manner, such as by ultrasonic welding. The conductors 5a and core elements are welded on the same top surfaces of the bus bars 9.

After connecting the conductors 5a of the flat cable 5 and lead wires L/W to the bus bars 9 in the inner case, a cover 7 is mounted on the inner case, or additional molding is applied to the inner case, to form an insulation structure. The inner cases 4 and 6 with the covers 7 are fixed in inner case containing sections 1a and 2a formed in the stationary body 1 and movable body 2, respectively. The inner cases may be molded over again, such as by insert molding, rather than utilizing the cover 7 for providing interlayer insulation.

In the conventional cable reel, the ends of plural flat cables are attached to respective inner cases, a cover is mounted on each inner case, and the inner cases are stacked. Lock members are required for securing and positioning the stacked inner cases. Further, an inner case and a cover are required for each flat cable. Consequently, the cable reel will become larger in size and require more parts, higher costs, and more space.

In particular, in the situation in which the interlayer insulation is provided by the cover, it is necessary to prepare two parts, including the inner case and the cover, for each flat cable. This results in an increase of parts-cost, die-cost and attaching time for the cover. Further, requirements for minimum thickness and clearances, as well as provision of a lock structure for the inner case and cover, will make an inner case with a cover larger in size.

In the situation in which the interlayer insulation is provided by over-molding a top opening in the inner case 6 rather than by providing a cover, it will be necessary to form a structure for preventing leakage of resin material, requiring additional dies and increased die-cost. This will require additional parts and limitations in design.

In the conventional cable reel, the conductors of the flat cable are welded to ends of the bus bars and the core elements of the lead wires are welded to the other ends of the bus bars on the same surfaces of the bars. This requires a welding portion having a suitable length on each of the opposite ends of the bus bar, thereby elongating the bus bars and enlarging the inner cases to which the distal end of the flat cable is attached.

In particular, in the case where an abutting wall (front stopper wall) for the conductors of the flat cable and an abutting wall for the core elements of the external electric wire are provided in the inner case, the walls must be formed on the same surfaces to oppose the bus bars. This results in elongation of the bus bars.

### SUMMARY OF THE INVENTION

One object of the present invention is to hold stacked units in given positions while maintaining insulation between the units in which flat cables are connected to external electric wires. Another object of the present invention is to provide insulation between units without providing a cover or over-molding. A further object of the present invention is to improve a connecting structure between bus bars and conductors of a flat cable and core elements of external electric wires, in order to reduce the size of the connecting portions and improve the function of the connecting structure.

An aspect of the present invention is a cable reel in which a movable inner sleeve is rotatably mounted to a stationary outer sleeve so as to form an annular chamber therebetween. The annular chamber contains flat cables having conductors connected to external wires through juxtaposed bus bars at opposite ends of the flat cables. The cable reel includes a plurality of units stacked to form an upper level and a lower level. Each of the units includes a plurality of juxtaposed bus bars having conductors of the flat cable welded on bottom surfaces of the bus bars at first ends thereof, and core elements of each of the wires welded on top surfaces of the bus bars at second opposite ends thereof.

Each of the units also includes a connection member made of an insulation material and configured to hold middle portions of the plurality of juxtaposed bus bars secured thereon. The connection member includes an upper stopper wall extending from a top surface thereof for abutting against ends of the core elements of each of the wires, and a lower stopper wall extending from a bottom surface thereof for abutting against an end of the flat cable. The connection member also includes upper partitions extending from the top surface of the connection member contiguous with the upper stopper wall and having portions perpendicular to the top surface of said connection member. The connection member also includes lower walls extending from the bottom surface of the connection member contiguous with the lower stopper wall and having portions perpendicular to the bottom surface of the connection member.

When the units are stacked to form an upper level and a lower level, the upper stopper wall of a lower level unit engages the perpendicular portions of the lower walls of an upper level unit, and the lower stopper wall of the upper level unit engages the perpendicular portions of the upper partitions of the lower level unit. In this manner, the stacked units are held at given positions and air insulation layers are formed between the bus bars, external wires, and flat cables of the upper level unit and the lower level unit.

The lower stopper wall of an upper level unit may be disposed above portions of the bus bars which are welded to the core elements of the external wires in order to cover ends of the core elements which are bent upwardly.

The insulation of the flat cable may be stripped to expose the conductors of the flat cable with the insulation remaining on distal ends of the conductors. The conductors may be coated with an insulation resin after being welded on the bottom surfaces of the bus bars.

By utilizing the upper stopper wall for abutting against the external electric wires and the lower stopper wall for abutting against the flat cable, it is possible to accomplish the positioning and insulation between the levels of units. Accordingly, the conventional cover can be eliminated. This results in reduction of material costs and die cost, elimination of the conventional lock structure for positioning the units between the levels, and reduced size of the cable reel.

Further, since the external electric wires are connected to the top surfaces of the bus bars and the flat cables are connected to the bottom surfaces of the bus bars, the upper stopper wall for the external electric wires and the lower stopper wall for the flat cable can be disposed on opposite surfaces of each connection member.

Further, if the core elements in the external electric wires connected to the bus bars bend upwardly at distal ends, the lower stopper wall of the connection member on the upper level unit can cover the bent distal ends to prevent the core elements on the lower level unit from coming into contact with the bus bars on the upper level unit. This can also allow for reduced size of the cable reel.

The core elements of the external electric wires and conductors of the flat cables can be connected to the bus bars by ultrasonic welding, resistance welding, or soldering.

Another aspect of the present invention is a cable reel in which a movable inner sleeve is rotatably mounted to a stationary outer sleeve so as to form an annular chamber therebetween. The annular chamber contains flat cables having conductors connected to external wires through juxtaposed bus bars at opposite ends of the flat cables. The cable reel includes a connection member made of an insulation material and a plurality of juxtaposed bus bars, each of the bus bars including top and bottom surfaces, first and second ends, and a middle portion located between the first and second ends. The middle portions of the juxtaposed bus bars are secured to the connection member. Conductors of the flat cable are welded to the first ends of the bus bars on one of either the top surfaces or the bottom surfaces. Core elements of each of the external wires are welded to the second ends of the bus bars on the other of either the top surfaces or the bottom surfaces. A hot melt coating is provided on either the surfaces of the bus bars on which the conductors of the flat cable are welded, extending from the middle portions to the first ends of the bus bars and covering the welded portions, or the surfaces of the bus bars on which the core elements of each of the external wires are welded, extending from the middle portions to the second ends of the bus bars and covering the welded portions.

The connection member may further include an upper stopper wall extending from a top surface thereof for abutting against ends of the core elements of each of the wires, and a lower stopper wall extending from a bottom surface thereof for abutting against an end of the flat cable. The connection member may further include upper partitions for the bus bars extending from the top surface of the connection member, and lower partitions for the bus bars extending from the bottom surface of the connection member.

The conductors of the flat cable may be welded to the bottom surfaces of the bus bars, and the core elements of each of the external wires may be welded to the top surfaces of the bus bars. The hot melt coating may be provided on both the surfaces of the bus bars on which the conductors of the flat cable are welded, extending from the middle portions to the first ends of the bus bars and covering the welded portions, and the surfaces of the bus bars on which the core elements of each of the external wires are welded, extending from the middle portions to the second ends of the bus bars and covering the welded portions.

As noted above, in the past conductors of flat cables and core elements of lead wires have been welded on the same surfaces of the bus bars at opposite ends thereof. However, according to the present invention, the conductors of the flat cable and the core elements of the external wires are welded on opposite top and bottom surfaces of the bus bars. This allows for the welding surfaces to be shortened since a length necessary for welding can be obtained on the respective top and bottom surfaces of the bus bars. Consequently, it is possible to reduce the size of the connecting portions between the flat cable and the external electric wires.

In addition, a hot melt is coated on the flat cable connecting side and/or the external electric wire connecting side on the bus bars extending from the middle portions to the opposite ends. This can achieve protection and reinforcement of the welded portions. After welding the bus bars and conductors of the flat cable and welding the bus bars and core elements of the external electric wire, the hot melt may be coated on the exposed bus bars and the welded portions between the bus bars and conductors and/or the core elements. After curing the hot melt, the hot melt forms an insulation coating. It will be preferable to spread and flatten the hot melt by pressing the hot melt by using a jig before curing.

Since coating of the hot melt forms an insulation layer, the conventional inner case and cover can be eliminated. This will achieve great reduction of production cost and increase of productivity. In addition, the juxtaposed bus bars can be held by the upper and lower partitions, thereby accomplishing insulation between the adjacent bus bars.

The exposed portions of the bus bars and the welded portions can be coated with an insulation material by hot melt without any additional cost. That is, the conventional cover to be mounted on the inner case is eliminated, costs of material and die can be reduced, the conventional lock structure for the cover and inner case can be eliminated, and the inner case can be simplified.

### BRIEF DESCRIPTION OF THE DRAWINGS

The above and other objects, features and advantages of the present invention will be made apparent from the following description of the preferred embodiments, given as non-limiting examples, with reference to the accompanying drawings in which:

FIG. 1 is a sectional side view of a connection member of a cable reel in accordance with the present invention, illustrating a connection position of a lead wire and a flat cable;

FIG. 2 is a bottom view of the connection member, illustrating a connection position of a lead wire and a flat cable;

FIG. 3 is a sectional side view of stacked connection members;

FIG. 4A is a plan view of the connection member;

FIG. 4B is a bottom view of the connection member;

FIG. 4C is a sectional side view of the connection member;

FIG. 5 is a plan view of a part of the flat cable;

FIG. 6 is a sectional top view of a conventional cable reel; and

FIG. 7 is an exploded perspective view of a conventional inner case.

### DETAILED DESCRIPTION OF THE PREFERRED EMBODIMENTS

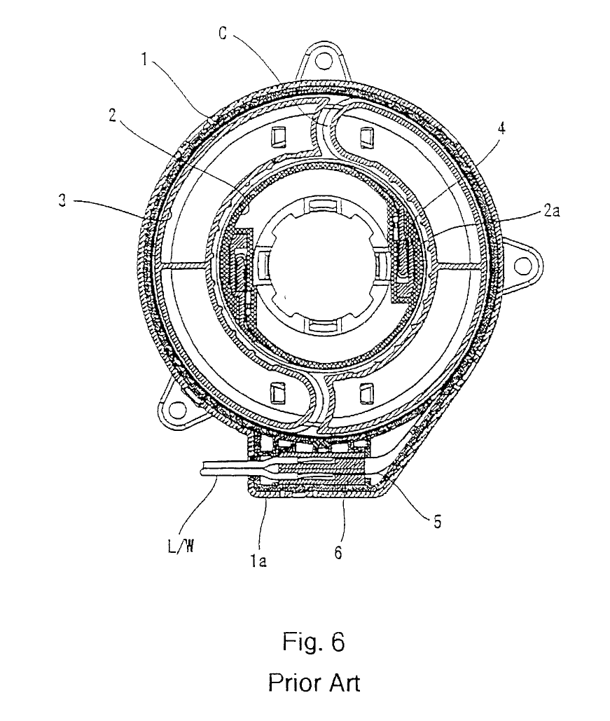

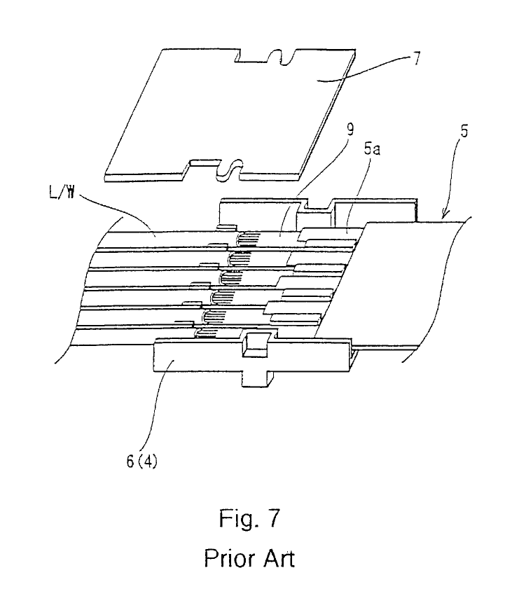

An embodiment of the cable reel in accordance with the present invention will be described below with reference to the drawings. The connection members of the present invention may be incorporated in a cable reel similar to the one shown in FIG. 6.

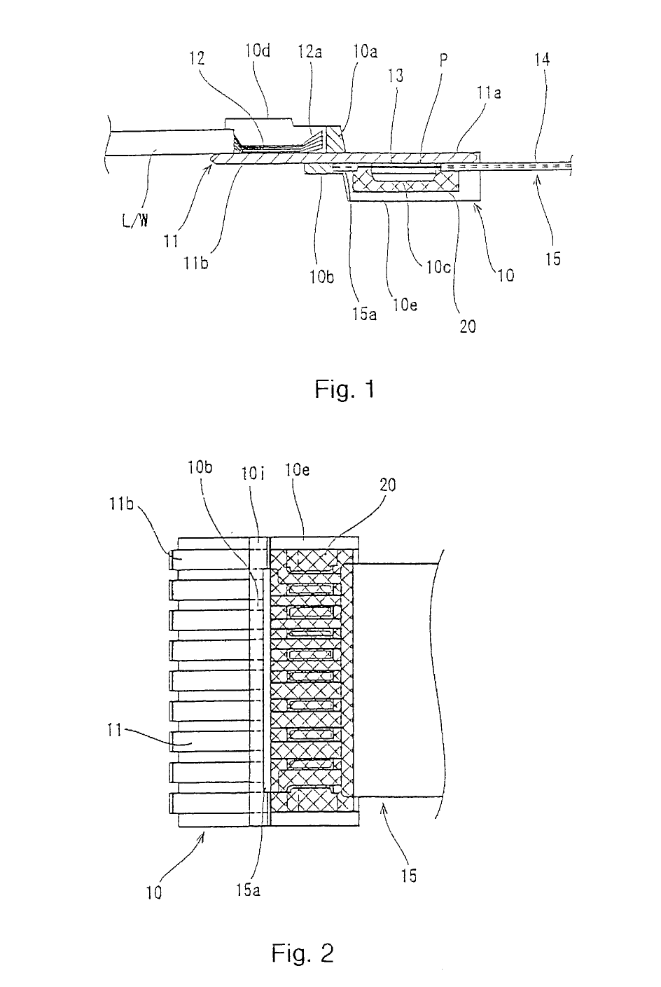

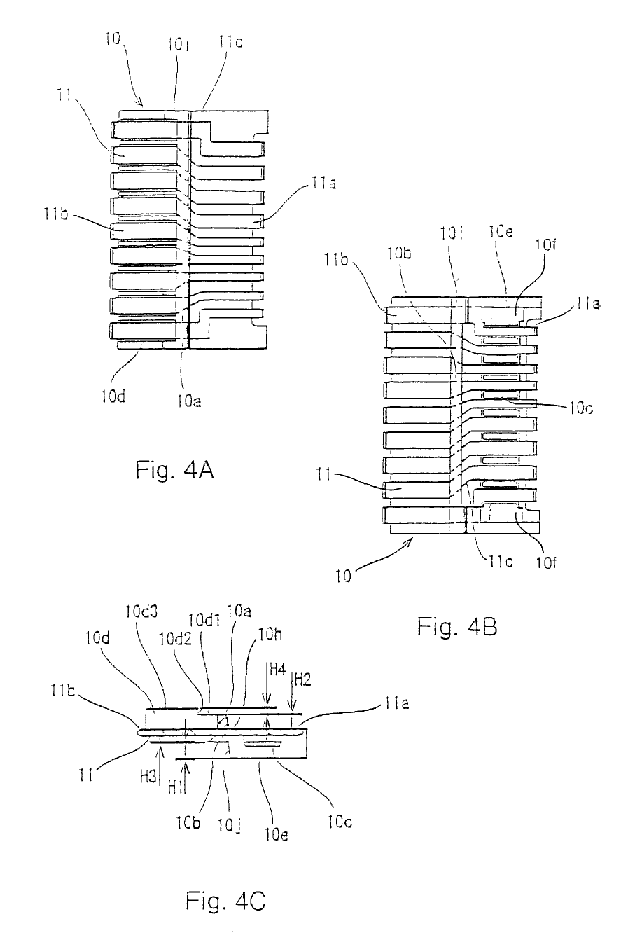

FIGS. 1-3, 4A, 4B and 4C show a connection member 10 which may be made of any suitable material, such as insulation resin material. Connection member 10 is configured for connection to an end of a flat cable 15. A plurality of juxtaposed bus bars 11 are mounted on the connection member 10 along middle portions of the bars 11. Conductors 13 of a flat cable 15 are connected to end portions 11a of each bus bar 11. Core elements 12 of lead wires L/W, which are part of external circuits, are connected to the opposite ends 11b of each bus bar 11.

The connection member 10 is provided on a substantially central portion in the longitudinal direction with a vertical coupling section 10i having through holes 10h through which the middle portions of the juxtaposed bus bars 11 extend. Vertical coupling section 10i may be formed in any suitable manner, such as by insert molding, so that vertical coupling section 10i covers the middle portions of the juxtaposed bus bars 11. An upper portion of the vertical coupling section 10i defines an upper stopper wall 10a while a lower portion of section 10i defines a lower stopper wall 10b. The upper and lower stopper walls 10a and 10b extend substantially perpendicular to the bus bars 11. The upper stopper wall 10a serves as an abutment wall for the distal ends of the lead wires L/W while the lower stopper wall 10b serves as an abutment wall for the distal end of the flat cable 15. The upper and lower stopper walls 10a and 10b are disposed at substantially the same longitudinal position on opposite surfaces of the connection member 10. The upper stopper wall 10a extends from the lead wire connection side of connection member 10, while the lower stopper wall 10b extends from the flat cable connection side of connection member 10.

Comb-like upper partitions 10d, which extend upwardly and separate juxtaposed bus bars 11, are provided on the connection member 10. Partitions 10d are located adjacent the upper stopper wall 10a toward the lead wire connection end. Each upper partition 10d is provided on the top surface with a lower stepped portion 10d1 contiguous with the top surface of the upper stopper wall 10a, and an upper stepped portion 10d3 connected to the lower stepped portion 10d1 by a substantially perpendicular portion 10d2. The upper stepped portion 10d3 has a height greater than a diameter of the lead wire L/W.

Comb-like lower partitions 10c, which extend downwardly and separate juxtaposed bus bars 11, are also provided on the connection member 10. Partitions 10c are located adjacent the lower stopper wall 10b toward the flat cable connection end. The connection member 10 is provided on the bottom surface with lower walls 10e projecting downwardly and having substantially perpendicular portions 10j formed on opposite sides of the lower stopper wall 10b in the width direction. The lower walls 10e are contiguous with lower stopper wall 10b.

A height H1 of the perpendicular portion 10j extending from the lower stopper wall 10b substantially corresponds to a projecting height H2 of the upper stopper wall 10a. Also, a height H3 of the lower stopper wall 10b substantially corresponds to a height H4 of the perpendicular portion 10d2 of the upper partitions 10d.

As described hereinafter, in the stacked condition, the upper stopper wall 10a of a connection member 10 on a lower level has a dimension suitable for fitting adjacent to the perpendicular portion 10j of a connection member 10 on an upper level, while the lower stopper wall 10b of the connection member 10 on the upper level has a dimension suitable for fitting adjacent the upper stepped portion 10d3 of the connection member 10 on the lower level.

Thus, the upper partitions 10d are contiguous with the upper stopper wall 10a on the connection member 10. The upper partitions 10d position the exposed opposite ends of the bus bars 111 on the lead wire connecting side, while the lower walls 10e and lower partitions 10c position the exposed opposite ends of the bus bars 11 on the flat cable connecting side.

Plural bus bars 11 are formed into suitable configurations, such as by stamping, are juxtaposed on the connection member 10 and integrated with the vertical coupling section 10i of the connection member 10 by extending through the through holes 10h in the vertical coupling section 10i. Bus bars 11 may be fitted into the through holes 10h or molded into the through holes during formation of the connection member 10.

A bus bar 11 is connected to a conductor 13 of the flat cable 15 on the bottom surface of an end 11a (right end in the drawings) of the bus bar 11, while the bus bar 11 is connected to the core elements 12 of a lead wire L/W on the top surface of the other end 11b of the bus bar 11. The bus bar 11 is provided on the intermediate portion with a pitch adjustable portion 11c for arranging opposite ends of the respective bus bars 11 at a given pitch.

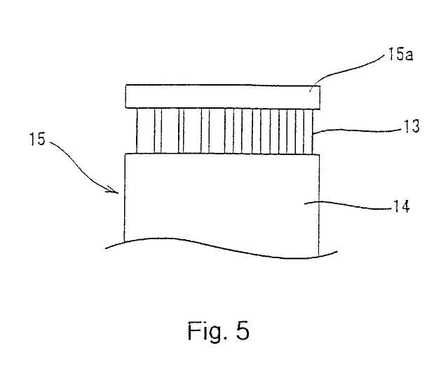

As shown in FIG. 5, an insulation sheath 14 of the flat cable 15 to be connected to the bus bars is stripped, except for a distal end 15a, to expose the conductors 13. The remaining sheath 14 on the distal end 15a of the flat cable 15 helps to maintain the conductors 13 in a juxtaposed arrangement. As shown in FIG. 1, the flat cable 15 is inserted onto the connection member 10 from the right side in the drawing so that the distal end 15a abuts against the lower stopper wall 10b. Then, the lower surfaces of the ends 11a of the bus bars 11 are connected to the conductors 13 in any suitable manner, such as by ultrasonic welding, resistance welding or soldering. The connected or welded portions P of the bus bars 11 and the conductors 13 are then insulated in any suitable manner, such as by coating a hot melt 20 on the flat cable 15. It should be noted that insulation of the connected portions is not limited hot melt but may be any suitable material, such as a semisolid adhesive.

As shown in FIG. 2, the hot melt 20 coats a space 10f near the lower wall 10e on the bottom surface of the connection member 10, as well as the connected portions P and the lower partitions 10c. This results in increased contact area between the hot melt 20 and the connection member 10 and more stable protection of the connected portions P. The hot melt 20 may be pressed in any suitable manner prior to curing, such as by a jig, in order to be spread and flatten so that the hot melt 20 will not interfere when the connection members 10 are stacked.

As shown in FIG. 1, the lead wires L/W are inserted onto the connection member 10 from the left side in the drawing so that the distal ends of the core elements 12 abut against the upper stopper wall 10a. Then, the upper surfaces of the other ends 11b of the bus bars 11 are connected to the core elements 12 in any suitable manner, such as by ultrasonic welding, resistance welding or soldering. Further, the connected or welded portions between the bus bars 11 and the core elements 12 of the lead wires L/W may also be coated with hot melt in order to obtain more stable protection of the connected portions and to enhance insulation thereof.

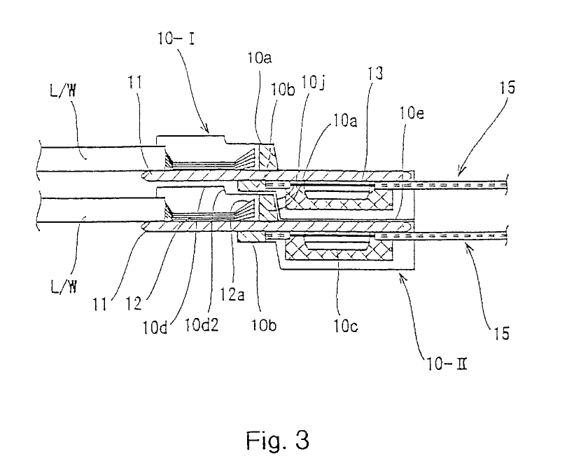

The bus bars 11 are secured to the connection member 10 and the lead wires L/W and flat cable 15 are respectively connected to the upper and lower surfaces of the bus bars 11 to form a unit. As shown in FIG. 3, the units may be stacked in the vertical direction.

In the stacked condition of the units, the lower configuration of the connection member 10-I (note FIG. 3) on the upper level unit is complementary with the upper configuration of the connection member 10-II on the lower level unit to form a fitting structure. That is, the upper stopper wall 10a of the connection member 10-II on the lower level unit engages the perpendicular portions 10j of the connection member 10-I on the upper level unit while the lower stopper wall 10b of the connection member 10-I on the upper level unit fits adjacent to the perpendicular portions 10d2 of the connection member 10-II on the lower level unit.

Therefore, it is not necessary to provide additional structure for positioning and holding the stacked units due to the presence of the upper stopper wall 10a for abutment of the lead wires L/W and the lower stopper wall 10b for abutment of the flat cable 15. By such an arrangement, the connection members 10-I and 10-II on the upper and lower level units can be positioned and held when stacked on each other.

Further, in the stacked condition, the core elements 12 of the lead wires L/W and the bus bars 11 on the connection member 10-II on the lower level are provided with an air insulation space, without contacting the conductors 13 of the flat cable 15 and the bus bars 11 on the connection member 10-I on the upper level. Such air insulation is provided by utilizing the upper partitions 10d projecting upward on the connection member 10-II on the lower level unit and the lower wall 10e projecting downward on the connection member 10-I on the upper level unit.

When the core elements 12 of the lead wires L/W are welded on the bus bars 11, the distal ends 12a of the core elements 12 may tend to bend upwardly. However, since the upper and lower stopper walls are disposed at substantially the same position on the top and bottom surfaces of the connection member 10, the lower stopper wall 10b of the upper level connection member 10-I covers the distal ends 12a to prevent the ends 12a from coming into contact with the bus bars 11 on the upper level unit.

The disclosed structure, in which the flat cable 15 and lead wires L/W are connected to the bus bars 11 fixed on the connection member 10, may be applied to the opposite ends of a flat cable in a scroll type cable reel, and may be applied to an end of an outer periphery, on which the conductors and lead wires are connected to each other at the same position, in a counter-turn type cable reel.

Although the invention has been described with reference to an exemplary embodiment, it is understood that the words that have been used are words of description and illustration, rather than words of limitation. Changes may be made within the purview of the appended claims, as presently stated and as amended, without departing from the scope and spirit of the invention in its aspects. Although the invention has been described with reference to particular means, materials and embodiments, the invention is not intended to be limited to the particulars disclosed. Rather, the invention extends to all functionally equivalent structures, methods, and uses such as are within the scope of the appended claims.

The present disclosure relates to subject matter contained in priority Japanese Application No. 2001-263515, filed on Aug. 31, 2001, and priority Japanese Application No. 2001-276551, filed on Sep. 12, 2001, the disclosures of which are herein expressly incorporated by reference it their entireties.

What is claimed:

1. A cable reel in which a movable inner sleeve is rotatably mounted to a stationary outer sleeve so as to form an annular chamber therebetween, said annular chamber containing flat cables having conductors connected to external wires through juxtaposed bus bars at opposite ends of said flat cables, said cable reel comprising:
a plurality of units stacked to form an upper level and a lower level, each of said units comprising:
a plurality of juxtaposed bus bars having said conductors of said flat cable welded on bottom surfaces of said bus bars at first ends thereof, and said core elements of each of said wires welded on top surfaces of said bus bars at second opposite ends thereof; and
a connection member made of an insulation material and configured to hold middle portions of said plurality of juxtaposed bus bars secured thereon, said connection member including an upper stopper wall extending from a top surface thereof for abutting against ends of said core elements of each of said wires, a lower stopper wall extending from a bottom surface thereof for abutting against an end of said flat cable, upper partitions extending from said top surface of said connection member contiguous with said upper stopper wall and having portions perpendicular to said top surface of said connection member, and lower walls extending from said bottom surface of said connection member contiguous with said lower stopper wall and having portions perpendicular to said bottom surface of said connection member;
wherein said upper stopper wall of said lower level unit engages said perpendicular portions of said lower walls of said upper level unit, and said lower stopper wall of said upper level unit engages said perpendicular portions of said upper partitions of said lower level unit, thereby holding said stacked units at given positions and forming air insulation layers between said bus bars, said external wires, and said flat cables of said upper level unit and said lower level unit.

2. The cable reel according to claim 1, wherein said lower stopper wall of said upper level unit is disposed above portions of said bus bars which are welded to said core elements of said external wires to thereby cover ends of said core elements which are bent upwardly.

3. The cable reel according to claim 1, wherein insulation of said flat cable is stripped to expose said conductors of said flat cable with the insulation remaining on distal ends of said conductors, and said exposed conductors are coated with an insulation resin after being welded on the bottom surfaces of said bus bars.

4. The cable reel according to claim 2, wherein insulation of said flat cable is stripped to expose said conductors of said flat cable with the insulation remaining on distal ends of said conductors, and said exposed conductors are coated with an insulation resin after being welded on the bottom surfaces of said bus bars.

5. A cable reel in which a movable inner sleeve is rotatably mounted to a stationary outer sleeve so as to form an annular chamber therebetween, said annular chamber containing flat cables having conductors connected to external wires through juxtaposed bus bars at opposite ends of said flat cables, said cable reel comprising:
a connection member made of an insulation material; and
a plurality of juxtaposed bus bars, each of said bus bars including top and bottom surfaces, first and second ends, and a middle portion located between said first and second ends;
wherein middle portions of said juxtaposed bus bars are secured to said connection member, conductors of the flat cable are welded to said first ends of said bus bars on one of either said top surfaces or said bottom surfaces, and core elements of each of the external wires are welded to said second ends of said bus bars on the other of either said top surfaces or said bottom surfaces;
wherein a hot melt coating is provided on either the surfaces of the bus bars on which the conductors of the flat cable are welded, extending from the middle portions to the first ends of the bus bars and covering the welded portions, or the surfaces of the bus bars on which the core elements of each of the external wires are welded, extending from the middle portions to the second ends of the bus bars and covering the welded portions.

6. The cable reel according to claim 5, said connection member further comprising:
an upper stopper wall extending from a top surface thereof for abutting against ends of said core elements of each of said wires, a lower stopper wall extending from a bottom surface thereof for abutting against an end of said flat cable, upper partitions for said bus bars extending from said top surface of said connection member, and lower partitions for said bus bars extending from said bottom surface of said connection member.

7. The cable reel according to claim 6, wherein the conductors of the flat cable are welded to said bottom surfaces of said bus bars, and the core elements of each of the external wires are welded to said top surfaces of said bus bars.

8. The cable reel according to claim 7, wherein a hot melt coating is provided on both surfaces of the bus bars on which the conductors of the flat cable are welded, extending from the middle portions to the first ends of the bus bars and covering the welded portions, and the surfaces of the bus bars on which the core elements of each of said external wires are welded, extending from the middle portions to the second ends of the bus bars and covering the welded portions.

9. The cable reel according to claim 5, wherein the conductors of the flat cable are welded to said bottom surfaces of said bus bars, and the core elements of each of the external wires are welded to said top surfaces of said bus bars.

10. The cable reel according to claim 5, wherein a hot melt coating is provided on both surfaces of the bus bars on which the conductors of the flat cable are welded, extending from the middle portions to the first ends of the bus bars and covering the welded portions, and the surfaces of the bus bars on which the core elements of each of said external wires are welded, extending from the middle portions to the second ends of the bus bars and covering the welded portions.
